(19) United States
(12) Patent Application Publication
(10) Pub. No.: US 2006/0059534 A1
(43) Pub. Date: Mar. 16, 2006

(54) Method for capturing a media segment

(76) Inventors: Eduardo Gomez, Miami Beach, FL (US); Ricardo Gomez, Miami Beach, FL (US)

Correspondence Address: SCHOX PLC, 209 N. MAIN STREET #200, ANN ARBOR, MI, 48104, US

(21) Appl. No.: 10/941,686

(22) Filed: Sep. 14, 2004

(51) Int. Cl. H04N 7/173; H04N 7/16

(52) U.S. Cl. 725/138; 725/116; 725/114

(57) ABSTRACT

In a first embodiment of the invention, the method includes: from a first source, receiving content data corresponding to a media work; receiving segment parameters from an input device; deriving data corresponding to a media segment of the media work based on the segment parameters; and sending the derived data to a second source.

### TECHNICAL FIELD

This invention relates generally to the field of media works, and more specifically to a new and useful method for capturing a media segment of a media work.

### BACKGROUND

As the price of broadband Internet access decreases, media-rich works (such as moving pictures, songs, and images) are becoming easier to purchase and download over the Internet. Because of this ease, many users have access to very large collections of media works. These large collections, however, have brought new challenges. Finding a particular media work to re-experience, or to recommend to a friend, has become a difficult problem for users.

Thus, there is a need in the field of media works to create a new and useful method to allow a media user to capture and store a media segment of the media work that will provoke the memory and ease the uncovering of a particular media work. This invention provides such method.

### BRIEF DESCRIPTION OF THE FIGURES

FIGS. 1 and 2 are schematic representations of the program and system that use variations of the first method of the invention;

FIG. 3 is a schematic representation of the relationship between a media work, content data of the media work, a media segment, and segment parameters for the media segment; and

FIGS. 4 and 5 are schematic representations of the program and system that use additional variations of the first method of the invention.

### DESCRIPTION OF THE PREFERRED EMBODIMENTS

The following description of three embodiments and multiple variations of the invention is not intended to limit the invention to these embodiments and variations, but rather to enable any person skilled in the art to make and use this invention.

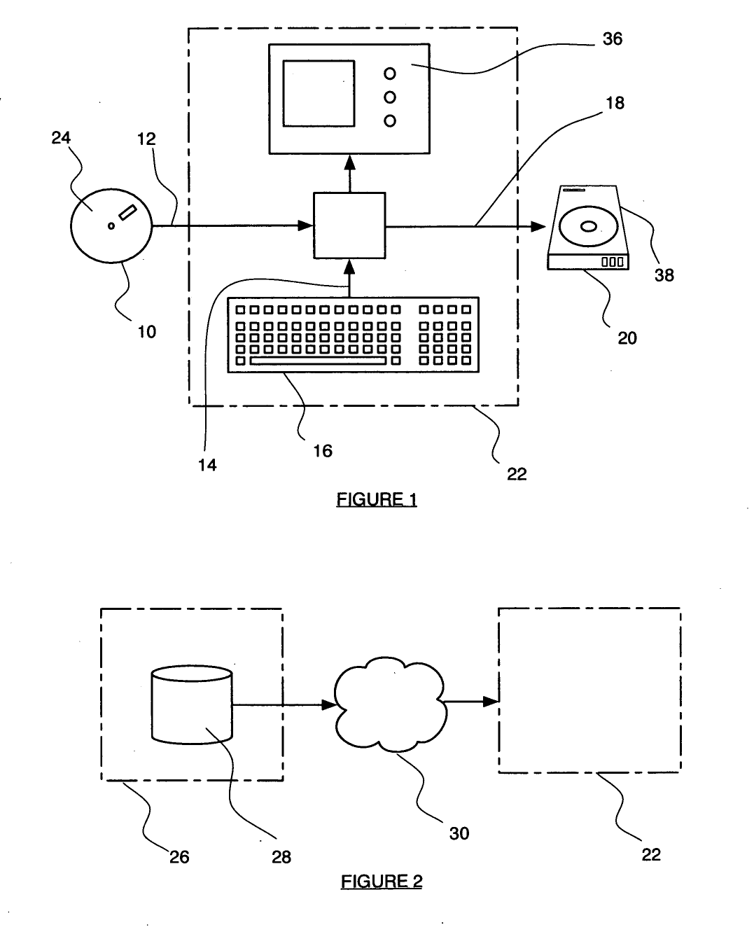

As shown in FIGS. 1 and 2, the method of a first embodiment of the invention includes: from a first source 10, receiving content data 12 corresponding to a media work; receiving segment parameters 14 from an input device 16; deriving data corresponding to a media segment of the media work based on the segment parameters 14; and sending the derived data 18 to a second source 20. The steps of the method are preferably performed by a program on a network connected to a suitable device or system 22, such as a computer (e.g., a PDA, a laptop, or a desktop), a radio frequency communication device (e.g., a cellular phone), or an entertainment device (e.g., an MP3 player, a home entertainment system, or a portable gaming device). The method may, however, alternatively be performed by any suitable combination of hardware, firmware, software, and other devices and systems.

The first source 10 preferably facilitates communication of the media work to the user. In a first variation (of FIG. 1), the first source 10 is a media storage device 24, such as a DVD, CD, mini-disk, hard-drive, magnetic tape, vinyl record, flash drive, or any other suitable device that can at least temporary store a moving picture, a song, an image, or a story. In this variation, the first source 10 is preferably directly connected (either with or without wires) to the device or system 22 of the user. In a second variation (of FIG. 2), the first source 10 is a media provider 26, such as a movie distributor, a television broadcaster, or any other suitable provider of media works. In this variation, the media provider 24 may communicate the media work from a network server 28 to a user through a suitable medium 30, such as radio frequency waves, the Internet, a satellite system, a cable network, a landline or wireless telephone network, or any other suitable medium. In alternative variations, the first source 10 is any suitable system that facilitates communication of the media work to the device or system 22 of the user.

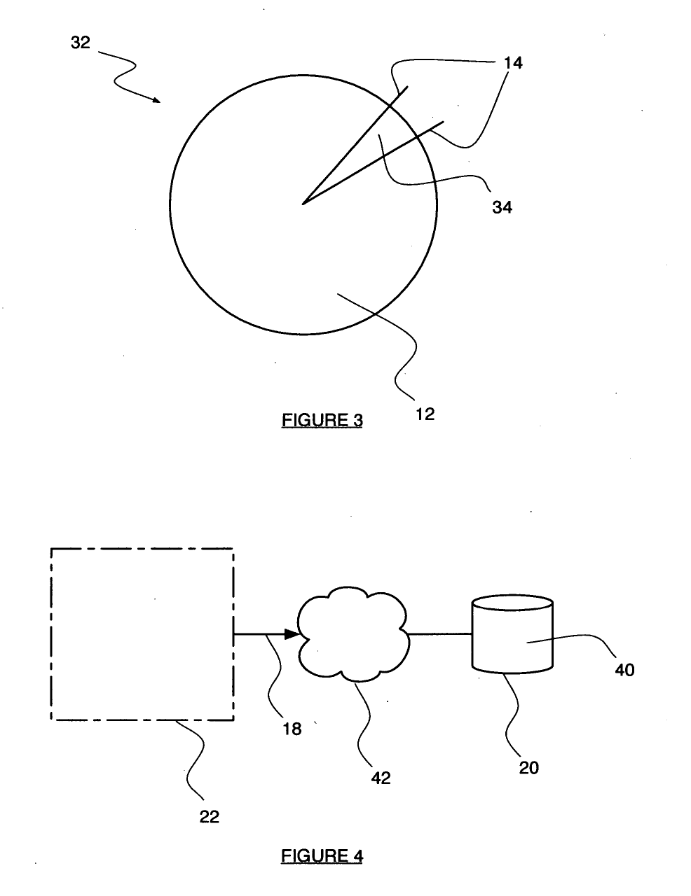

As shown in FIG. 3, the media work 32 is preferably a moving picture, a song, an image, or another media-rich work having a relatively large amount of digital data. By “relatively large amount of digital data”, we mean any amount that is time-consuming to download via the Internet. Within this document, we intend “moving pictures” to include all audio-video works (such as movies, television shows, and video games), we intend “song” to include all audio works (such as radio shows and speeches), and we intend “image” to include all two dimensional works (such as photographs and drawings). The media work 32 may alternatively be a “story” or another media-light work having a relatively small amount of digital data. Within this document, we intend “story” to include all text works (such as novels and blog entries). The media work 32, however, may alternatively be any suitable work.

The content data 12 of the media work 32 preferably allows communication of the media work 32. For example, if the media work 32 is a moving picture, the content data 12 preferably includes audio-video information in any suitable format (such as .mpg). If the media work 32 is a song, the content data 12 preferably includes audio information in any suitable format (such as .mp3). If the media work 32 is an image, the content data 12 preferably includes raster or bit-map information in any suitable format (such as .jpg). If the media work 32 is a story, the content data 12 preferably includes text information in any suitable format (such as .txt). The content data 12, however, may alternatively include any suitable information that allows communication of the media work 32.

The media segment 34 is preferably a relatively small and generally continuous segment of the media work 32, such as a 30-second scene of a moving picture, a lyric or riff in a song, a particular object or layer within an image, or paragraph or quote from a story. Alternatively, the media segment 34 may be of any size and may, in certain cases, be discontinuous. The media segment 34 is preferably, however, not a segment of the media work 32 that is already captured within the media work 32. For example, the media segment 34 is preferably neither an entire chapter of a movie on a DVD, nor an entire track of an album on a CD.

The segment parameters 14 preferably allow a user to identify a particular media segment of the media work. The segment parameters 14 may include time parameters (such as time-in and time-out) when the content data 12 includes audio-video information or when the content data 12 includes audio information. The segment parameters 14 may alternatively include coordinates or layer information when the content data 12 includes raster or bit map information, or word or page number information when the content data 12 includes text information. The segment parameters 14 may, however, alternatively include any suitable information that allows a user to identify a media segment of the media work.

As shown in FIGS. 1 and 2, the input device 16 preferably facilitates selection of the media segment by a user. The input device 16 preferably includes a mouse, keyboard, microphone, any other suitable device, or any combination of any permutation of suitable devices. Alternatively, the input device 16 may include any suitable device that facilitates selection of the media segment by a user.

Preferably, the method of the first embodiment further includes sending at least a portion of the media work to an output device 36. This step preferably occurs between receiving the content data 12 corresponding to the media work and receiving segment parameters 14 from an input device 16. The step may, however, occur at any suitable time or position. By sending at least a portion of the media work to the output device 36, the user is able to experience the media work and more intelligently select a particular media segment of the media work. The output device 36 preferably facilitates an experience of the media work by the user. The output device 36 preferably includes a monitor, a speaker, a tactile device, any other suitable device, or any suitable combination of any permutation of suitable devices. Further, the output device 36 is preferably directly connected (either with or without wires) to the device or system 22 of the user. Alternatively, the output device 36 may include any suitable device that facilitates an experience of the media work by the user and may be connected in any suitable manner to the device or system 22 of the user.

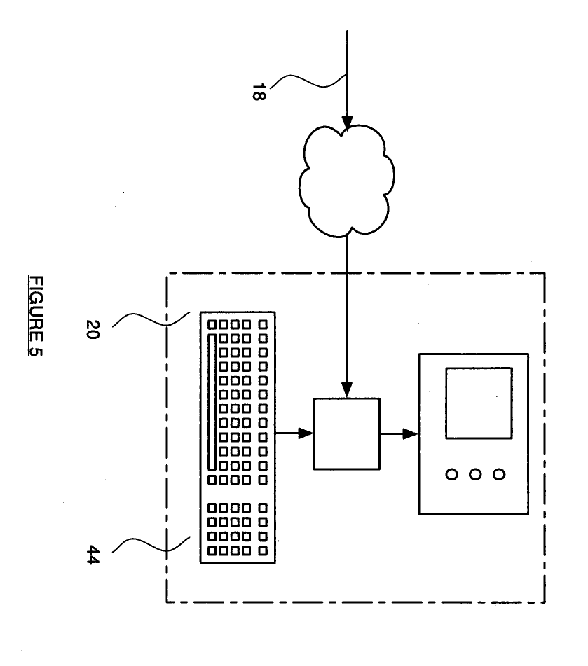

The second source 20 preferably facilitates storage of the derived data 18 for later retrieval by the same user or by other users. In a first variation, the second source 20 is a data storage device 38, such as a DVD-R, CD-R, mini-disk, hard-drive, magnetic tape, flash drive, or any other suitable device that can at least temporary store the derived data 18. In a second variation, as shown in FIG. 4, the second source 20 is a network server 40. In this variation, the user may communicate the derived data 18 to the network server through a suitable medium 42, such as radio frequency waves, the Internet, a satellite system, a cable network, a landline or wireless telephone network, or any other suitable medium. In a third variation, a shown in FIG. 5, the user may communicate the derived data 18 to a peer device 44. The peer device 44 may be a computer (such as a PDA, a laptop, or a desktop), a radio frequency communication device (such as a cellular phone), or an entertainment device (such as an MP3 player, a home entertainment system, or a portable gaming device). In this variation, a payment for these services could be required. Payment could be made by authentication as a member, authentication as a subscriber, direct payment, or some other combination or permutation of similar techniques. In alternative variations, the second source 20 is any suitable system that facilitates storage of the derived data 18 for later retrieval and use by the same user or by other users.

In a second embodiment, the method includes the steps of the first embodiment with a modification to the step of receiving segment parameters 14 from an input device 16 and a corresponding modification to the step of deriving data.

In the second embodiment, the step of receiving segment parameters 14 also includes receiving other information, such as segment theme, keywords, mini-segment parameters, and output device type. In a first variation, the step includes receiving a segment theme from the input device 16. The segment theme preferably represents the subject matter or user's perception of the media segment. For example, the user may input “classic 80's scenes” for the “Bueller? Bueller? Bueller?” scene in the movie “Ferris Bueller's Day Off”, or may input “killer guitar riff” for the opening portion of the song “Whole Lotta Love” by Led Zeppelin. These segment themes may be provided as an inclusive list to the user, or may be entered by the user. In a second variation, the step includes receiving keywords from the input device 16. The keywords preferably represent the actors, authors, or artists featured in the media segment. Following the above examples, the user may input “Ben Stein” or “Jimmy Page.” Alternatively, the actor, author, and artist information may be retrieved from a suitable database, such as www.imdb.com, and a suitable list may be presented to the user. In a third variation, the step of receiving input parameters includes receiving mini-segment parameters 14 from the input device 16. The mini-segment parameters 14 preferably aid in the identification of the media segment. Following the above examples, the user may select just the audio portion of the line “Bueller? Bueller? Bueller?” to aide in the identification of that particular scene, or may select just the first five notes of “Whole Lotta Love” to represent that particular opening portion. In a fourth variation, the step of receiving input parameters includes receiving an output device type from the input device 16. The output device type preferably represents the current type of output device 36 for the user. For example, the output device 36 type may include “HDTV monitor”, “small mobile phone screen”, “high definition speakers” or any other description of the type of output device 36 for the user. The step of receiving input parameters may, of course, include receiving a combination of the segment theme, the keywords, the mini-segment parameters, and the output device type, or may include any other suitable permutation of these inputs or other inputs.

In the second embodiment, the step of deriving data preferably includes deriving meta data corresponding to the media segment of the media work. The meta data preferably includes information to identify the media work and the media segment, but preferably does not include the actual content data of the media segment. Consequently, the meta data is preferably based on a work identification and the segment parameters 14. The meta data may, however, be alternatively based on any suitable information to identify the media work and the media segment. Further, the meta data may alternatively include additional information, such as the segment theme, the keywords, the mini-segment parameters, the input device type, or any combination or permutation of suitable parameters and information.

In a third embodiment, the method includes the steps of the first embodiment with an alternative modification to the step of deriving data. In the this embodiment, the step of deriving data preferably does not include deriving meta data for the media segment, but rather includes deriving content data corresponding to the media segment of the media work based on the segment parameters 14. The content data preferably facilitates communication and reproduction of the media segment without any reference to the content data 12 of the media work. Consequently, the content data of the media segment is preferably based on the content data 12 of the media work and on the segment parameters 14. The content data may, however, be alternatively based on any suitable information to facilitate communication and reproduction of the media segment. Further, the content data may alternatively include additional information, such as the segment theme, the mini-segment parameters, the input device type, or any combination or permutation of suitable parameters and information.

Preferably, the derivation of the content data in the third embodiment also includes a format conversion. The content data 12 for the media work is preferably coded in a first format (such as DV or MPEG-4 for audio-video works) that is generally used in home theater systems (which typically include a receiver and 5+ speakers). This format, however, is not optimized for bandwidth-limited communications, such as communications through radio frequency waves, the Internet, or a landline or wireless telephone network. Thus, the content data for the media segment is preferably converted and/or compressed to a second format (such as .swf or .mp3) that is generally used in a computer system on a network (such as the Internet).

As a person skilled in the art will recognize from the previous detailed description and from the figures and claims, modifications and changes can be made to the preferred embodiments and variations of the invention without departing from the scope of the invention defined in the following claims.

I claim:

1. A method for capturing a media segment, the method comprising:
from a first source, receiving content data corresponding to a media work;
receiving segment parameters from an input device;
deriving data corresponding to a media segment of the media work based on the segment parameters; and
sending the derived data to a second source.

2. The method of claim 1, wherein receiving content data includes receiving content data from a media storage device.

3. The method of claim 1, wherein receiving content data includes receiving content data from a media provider.

4. The method of claim 3, wherein receiving content data includes receiving content data via the Internet.

5. The method of claim 1, further comprising:
sending at least a portion of the media work to an output device.

6. The method of claim 1, wherein deriving data includes deriving meta data corresponding to the media segment of the media work based on the segment parameters.

7. The method of claim 6, further comprising:
receiving a segment theme from the input device, wherein the method of deriving meta data is further based on the segment theme.

8. The method of claim 7, further comprising:
receiving mini-segment parameters from the input device, wherein the method of deriving meta data is further based on the mini-segment parameters.

9. The method of claim 7, further comprising:
receiving an output device type from the input device, wherein the method of deriving meta data is further based on the output device type.

10. The method of claim 1, wherein deriving data includes deriving content data corresponding to the media segment of the media work based on the segment parameters.

11. The method of claim 10, wherein deriving content data includes converting the content data corresponding to the media work from a first format to a second format.

12. The method of claim 11, wherein the first format is a format generally used in a home theater system and the second format is a format generally used in a computer system connected to the Internet.

13. The method of claim 1, wherein sending the derived data includes sending the derived data to a data storage device.

14. The method of claim 1, wherein sending the derived data includes sending the derived data via the Internet.

15. The method of claim 1, wherein sending the derived data includes sending the derived data to a peer device.

16. The method of claim 15, further comprising:
before sending the derived data to a peer device, requiring at least one from the group consisting of: authentication as a member, authentication as a subscriber, and payment.

17. The method of claim 1, wherein the content data of the media work includes audio information and the segment parameters include time parameters.

18. The method of claim 17, wherein the media work is a song.

19. The method of claim 17, wherein the content data of the media work also includes video information.

20. The method of claim 19, wherein the media work is a moving picture.
